(19) United States
(12) Patent Application Publication
(10) Pub. No.: US 2010/0242753 A1
(43) Pub. Date: Sep. 30, 2010

(54) Screen Printing Press and Method

(75) Inventor: Matthias Gygi, Schmitten (CH)

Correspondence Address: CROMPTON, SEAGER & TUFTE, LLC, 1221 NICOLLET AVENUE, SUITE 800, MINNEAPOLIS, MN, 55403-2420, US

(73) Assignee: KBA-GIORI S.A., CH-1000 Lausanne 22 (CH)

(21) Appl. No.: 12/673,748

(22) PCT Filed: Aug. 15, 2008
(86) PCT No.: PCT/IB2008/053281

§ 371 Date: Apr. 7, 2010

(30) Foreign Application Priority Data
Aug. 16, 2007 (EP) 07114465.3

(51) Int. Cl. B41L 13/04; B41M 1/12

(52) U.S. Cl. 101/116; 101/129

(57) ABSTRACT

There is described a sheet-fed or web-fed screen printing press, especially for the production of banknotes and like securities, comprising an impression cylinder, a first screen printing unit cooperating with the impression cylinder for applying a first ink pattern onto successive sheets or web portions, at least a second screen printing unit cooperating with the impression cylinder for applying a second ink pattern onto the successive sheets or web portions, which second screen printing unit is located downstream of the first screen printing unit with respect to a direction of rotation of the impression cylinder, and an intermediate drying unit located between the first and second screen printing units. The intermediate drying unit is adapted to perform superficial drying of the first ink pattern applied by the first screen printing unit before application of the second ink pattern by the second screen printing unit, which superficial drying involves only the drying of an outer superficial portion of the first ink pattern. Preferably, the second screen printing unit is adapted to apply the second ink pattern in close proximity to the first ink pattern or at least in a partially overlapping manner onto the first ink pattern.

### TECHNICAL FIELD

The present invention generally relates to a sheet-fed or web-fed screen printing press, especially for the production of banknotes and like securities, of the type comprising an impression cylinder, a first screen printing unit cooperating with the impression cylinder for applying a first ink pattern onto successive sheets or web portions, at least a second screen printing unit cooperating with the impression cylinder for applying a second ink pattern onto the successive sheets or web portions, which second screen printing unit is located downstream of the first screen printing unit with respect to a direction of rotation of the impression cylinder, and an intermediate drying unit located between the first and second screen printing units.

The present invention also relates to a method for carrying out screen printing of successive sheets or web portions, especially for the production of banknotes and like securities, onto a screen printing press of the above-mentioned type.

### BACKGROUND OF THE INVENTION

A printing press of the above-mentioned type (except for the provision of the intermediate drying unit) is already known as such in the art from International application No. WO 97/34767 filed in the name of the present Applicant. A printing press of this type is sold by the Applicant under the trade name NotaScreen®. Further details regarding screen printing presses can be found in European patent applications EP 0 723 864, EP 0 769 376 and in International applications WO 97/29912, WO 03/093013, WO 2004/096545 and WO 2005/102699.

Screen printing (also referred to as “silk-screen printing” or “serigraphy”) is in particular adopted, in the context of the production of security documents, such as banknotes, to print optically-variable patterns onto the documents, including so-called iridescent patterns and OVI® (Optically Variable Ink) patterns (OVI® is a registered trademark of SICPA Holding SA, Switzerland). Such patterns are printed using inks or varnishes containing special pigments or flakes producing optically variable effects.

According to International application No. WO 97/34767, the first and second screen printing units are designed in such a way as to apply respective ink patterns in a non-overlapping manner, the press being arranged in such a way that the second screen printing unit does not enter into contact with the patterns previously applied by the first screen printing unit.

According to first embodiments disclosed in International application No. WO 97/34767, the second screen printing unit comprises a stencil cylinder exhibiting a more complex configuration than that of the first screen printing unit with raised and lowered surface portions, the lowered surface portions being non-printing portions and coinciding with the location of the patterns applied by the first screen printing unit. Depending on the actual configuration of the stencil cylinder of the second screen printing unit, the doctor blade arrangement of the second screen printing further needs to be adapted in shape and/or in the way it is operated.

According to further embodiments disclosed in International application No. WO 97/34767, the stencil cylinder of the second screen printing unit is designed to be elastically deformable and annular portions are provided to prevent deformation of the stencil cylinder at selected locations corresponding to the locations of the ink patterns applied by the first screen printing unit. Furthermore, the doctor blade arrangement of the second screen printing unit comprises a comb-shaped doctor blade that its adapted to cooperate with the deformable locations of the stencil cylinder only.

The non-overlapping application of ink patterns using the above known printing press configurations has always been held to be necessary in order to avoid ink contamination problems and ensure a good printing quality. With the machine configurations of International application No. WO 97/34767, it is accordingly not possible to apply patterns made of different inks in close proximity one to the other or even in an overlapping manner. This constitutes a limitation of these machine configurations which is desirable to be overcome.

International application No. WO 2005/000585, also in the name of the present Applicant, discloses a screen printing press of the above-mentioned type which is further adapted to perform orientation of magnetically-orientable pigments contained in the printed ink by applying a magnetic field to the freshly printed pattern of ink prior to drying thereof. According to one embodiment discussed in International application No. WO 2005/000585, it is envisaged to apply two patterns of ink one on top of the other using the first and second screen printing units and to perform drying of the first pattern of ink applied by the first screen printing unit prior to the application of the second pattern of ink with the second screen printing unit. Drying could be performed using UV lamps or any other equivalent drying system. International application No. WO 2005/000585 is however totally silent as to how the intermediate drying unit is actually to be integrated in the screen printing press.

As a matter of fact, the use of an intermediate drying unit as briefly suggested in International application No. WO 2005/000585 had not actually been put into practice by the Applicant. It was indeed thought that the close proximity of the two screen printing units in the above-described prior machine configurations would make it impossible to carry out a proper drying of the first ink pattern applied by the first screen printing unit before application of the second ink pattern by the second downstream-located screen printing unit.

### SUMMARY OF THE INVENTION

A general aim of the invention is therefore to provide an improved screen printing press of the type comprising an impression cylinder, at least two screen printing units cooperating with the impression cylinder and an intermediate drying unit located between the first and second screen printing units.

A further aim of the invention is to provide a screen printing press of the above-mentioned type capable of applying at least two different ink patterns in closed proximity to one another or in at least a partially overlapping manner.

A further aim of the present invention is to provide such a solution that it is easily and cost-efficient to implement in practice.

Still another aim of the present invention is to provide a solution that guarantees that there is no contamination between the inks applied by the first and second screen printing units or degradation of the printing quality.

These aims are achieved thanks to the solution defined in the claims.

According to the invention, the intermediate drying unit is adapted to perform superficial drying of the first ink pattern applied by the first screen printing unit before application of the second ink pattern by the second screen printing unit, which superficial drying involves only the drying of an outer superficial portion of the first ink pattern.

Thanks to this solution, a proper integration of the intermediate drying unit in the screen printing press can be ensured, it being further possible to greatly simplify the configuration of the second screen printing unit. Indeed, it is not anymore necessary to design and/or operate the second screen printing unit in the way taught in International application WO 97/34767. In the context of the present invention, the two screen printing units can accordingly and advantageously make use of similar stencil cylinders and doctor blade arrangements, which greatly simplifies the machine construction and lowers the manufacturing and operating costs of the printing press.

According to a preferred embodiment, the second screen printing unit is adapted to apply the second ink pattern in close proximity to the first ink pattern or at least in a partially overlapping manner onto the first ink pattern.

It shall again be appreciated that, prior to the present invention, it had been held that the close proximity of the two screen printing units in the above-described prior machine configurations made it impossible to carry out a proper drying of the first ink pattern applied by the first screen printing unit before application of the second ink pattern by the second downstream-located screen printing unit. Tests carried out by the Applicant have however shown that this was a preconceived idea and that the provision of an intermediate drying unit between the first and second screen printing unit brought unexpected advantages insofar that it was sufficient to dry a superficial portion of the first ink pattern applied by the first screen printing unit before application of the second ink pattern by the second screen printing unit, and not the first ink pattern as a whole. It has in particular been observed that the superficial drying of the first ink pattern was sufficient to avoid any contamination of inks and ensure a high printing quality.

According to a preferred embodiment of the invention, the drying unit is a UV unit for emitting UV radiation, which unit is particularly suited in connection with the drying of UV-cured inks and varnishes.

In the context of the use of UV radiation, the intermediate drying unit is advantageously shielded such as to avoid interference with the first and second screen printing units that would be caused by the propagation of UV radiations emitted by the intermediate drying unit. Further means might be provided to ensure that the operator operating the press is also properly protected from UV radiation emitted by an intermediate UV drying unit.

The present invention also encompasses a method for carrying out screen printing of successive sheets or web portions, especially for the production of banknotes and like securities, onto a screen printing press of the above-mentioned type, wherein the method comprises the step of performing superficial drying of the first ink pattern applied by the first screen printing unit before application of the second ink pattern by the second screen printing unit, which superficial drying involves only the drying of an outer superficial portion of the first ink pattern. This method may advantageously further comprise the step of performing final drying of the first and second ink patterns downstream of the second printing unit.

Further advantageous embodiments of the invention form the subject-matter of the dependent claims and are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIG. 1 is a schematic side view of a screen printing press according to an embodiment of the invention;

FIG. 2 is a schematic perspective view of a possible configuration of the screen printing units of the printing press of FIG. 1;

FIG. 3 is a schematic partial sectional view of the screen printing unit of FIG. 2 with its doctor blade;

FIG. 4 is a schematic side view of a preferred embodiment of the intermediate drying unit;

FIGS. 5a to 5d are schematic views illustrating the drying process of an ink pattern applied using the printing press of the present invention; and

FIGS. 6a and 6b are two views illustrating possible examples of ink patterns that can be applied using the printing press of the present invention.

### DETAILED DESCRIPTION OF EMBODIMENTS OF THE INVENTION

The invention will be described hereinafter in the context of a sheet-fed screen printing press for printing security papers, in particular banknotes. The general configuration of the screen printing press is similar to that described in International application WO 97/34767. The invention is however equally applicable to a web-fed screen printing press.

Within the scope of the present invention, it shall be understood that the expression “screen printing” is equivalent to “silk-screen printing” or “serigraphy” which are also commonly used in the art. “Screen printing” generally refers to a printing process whereby ink is applied using a so-called stencil provided with a pattern of small apertures corresponding to the ink patterns to be applied, ink being forced through the apertures of the stencil using a doctor blade arrangement (such as discussed in International application No. WO 2004/096545).

Within the scope of the present invention, the expression “drying” will be understood as referring equally to a drying process whereby liquid solvent constituents are being evaporated (which drying process is typically induced by thermal or infrared radiation) and a curing process whereby polymer constituent are hardened by cross-linking of polymer chains (which curing process is typically induced by UV radiation).

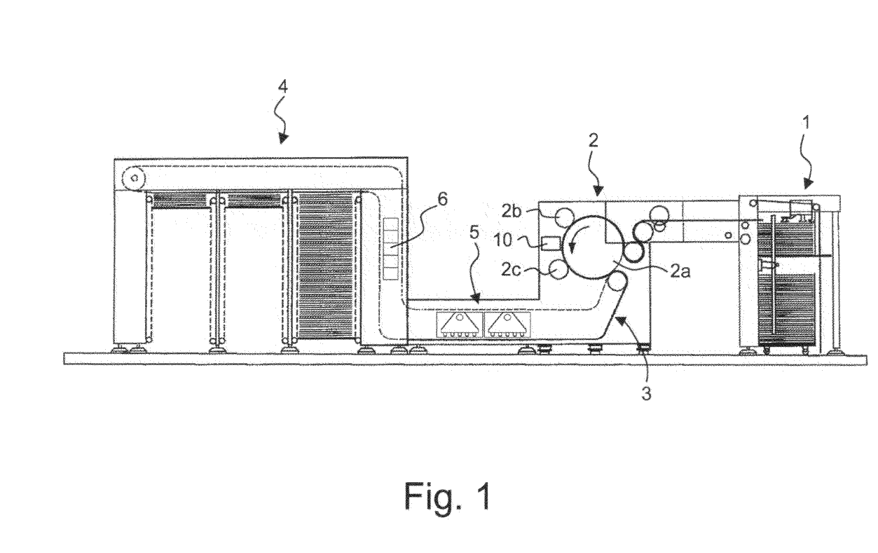

An embodiment of a sheet-fed screen printing press according to the invention is represented in FIG. 1. This screen printing press comprises a feeding station 1 for feeding successive sheets to a screen printing group 2 where ink patterns are applied onto the sheets. In this example the printing group 2 comprises an impression cylinder 2a cooperating with first and second screen printing units 2b, 2c placed in succession along the printing path of the sheets. Once processed in the printing group 2, the freshly printed sheets are transported by means of a conveyor system 3 to a delivery station 4 comprising a plurality of delivery pile units, three in this example. The conveyor system 3 is typically an endless chain conveyor system comprising a plurality of spaced-apart gripper bars (not shown in FIG. 1) extending transversely to the sheet transporting direction, each gripper bar comprising clamping means for holding a leading edge of the sheets.

Drying units 5, 6 are preferably further located along the path of the conveyor system 3 between the printing group 2 and the delivery station 4. These drying units 5, 6 are used to perform final drying and curing of the screen-printed ink patterns. Drying unit 5 is preferably a thermal drying unit for applying thermal energy to the sheets, while drying unit 6 is preferably a UV dryer for subjecting the sheets to UV radiation. The combination of drying units 5, 6 ensures adequate drying and curing of the applied ink patterns and assures that the brilliance and optically variable effect of the screen-printed features are maximized and prolonged. One or both of the drying systems 5, 6 can be installed on the machine depending on the production requirements.

According to the present invention, an intermediate drying unit 10 is located between the first and second screen printing units 2b, 2c. This intermediate drying unit 10 is adapted to dry a superficial portion of the first ink patterns applied by the first screen printing unit 2b before application of the second ink patterns by the second screen printing unit 2c. In the context of the present invention, it shall be understood that the superficial drying performed by the intermediate drying unit 10 involves only the drying of an outer superficial portion of the first ink pattern applied by the first screen printing unit 2b.

Tests carried out by the Applicant have shown that a superficial drying of the layer of ink deposited by the first screen printing unit 2b is sufficient to avoid the problems of ink contamination and ensure high printing quality. In other words, full drying or curing of the ink patterns applied by the first screen printing unit 2b is not necessary, which means that the energy requirements of the intermediate drying unit 10 can be kept low.

In this context, the intermediate drying unit 10 can advantageously include one or more pulsed lamps designed to produce flashes at a certain frequency f, which frequency f can optionally be adjusted as a function of the conveyance speed of the printed sheets. In that respect, the screen printing press of the present invention is adapted to process sheets at a speed of the order of 10,000 to 12,000 sheets per hour (sph), or lower. In such case, it has been found suitable to operate an intermediate drying unit of the type comprising pulsed lamps so as to produce flashes at a frequency f of the order of 40 to 50 Hz (and with a pulse duration of the order of less than one millisecond) when the printing press operates at 10,000-12,000 sph, which amounts to approximately 10 to 20 flashes per sheet. Power levels of the order of 15-20 kJ/s have been found to be suitable for this application.

Thanks to the intermediate drying unit 10, the two screen printing units 2b and 2c can accordingly and advantageously make use of similar stencil cylinders and doctor blade arrangements.

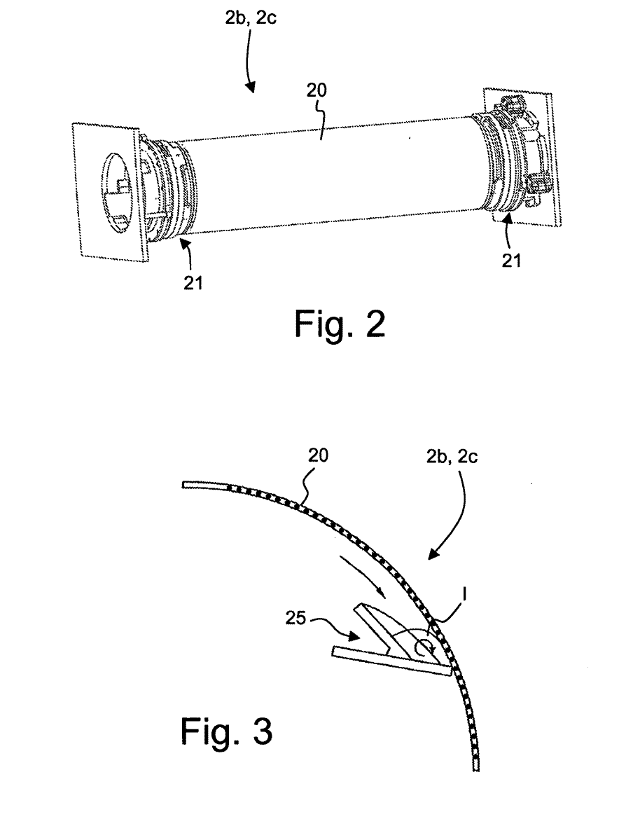

An example of a suitable screen printing unit arrangement for units 2b and 2c is illustrated in FIGS. 2 and 3. As illustrated in FIG. 2, both units 2b, 2c may comprise a stencil cylinder 20 with a continuous cylindrical surface, i.e. with a cylindrical outer circumference devoid of any discontinuous portions. This stencil cylinder 20 is advantageously mounted at its extremities on two head pieces (not referenced) which are mounted for rotation between two bearing arrangements 21 of the type comprising rotatable claw members as taught in International application No. WO 03/093013 in the name of the present Applicant.

It shall be appreciated that, in operation, the stencil cylinder 20 is made to rotate (in a clockwise direction in FIG. 1), while the doctor blade 25 (not shown in FIG. 2) that is located inside the stencil cylinder 20 (see FIG. 3) is not made to rotate and pushes the ink I through apertures provided in the surface of the stencil cylinder 20, which apertures are defined in function of the design of the ink patterns to be applied. The doctor blade 25 can be designed in the manner taught in International application No. WO 2004/096545 with integral grooves designed to improve the flow of ink on the doctor blade 25.

The doctor blade 25 is advantageously coupled to a known control mechanism (not shown) for selectively retracting the doctor blade 25 from the inner circumference of the stencil cylinder 20 when the doctor blade 25 passes in front of a cylinder pit of the impression cylinder 2a. A detailed description of such a control mechanism may be found in European patent application No. EP 0 723 864. Such a control mechanism could be omitted in the case of printing on a web.

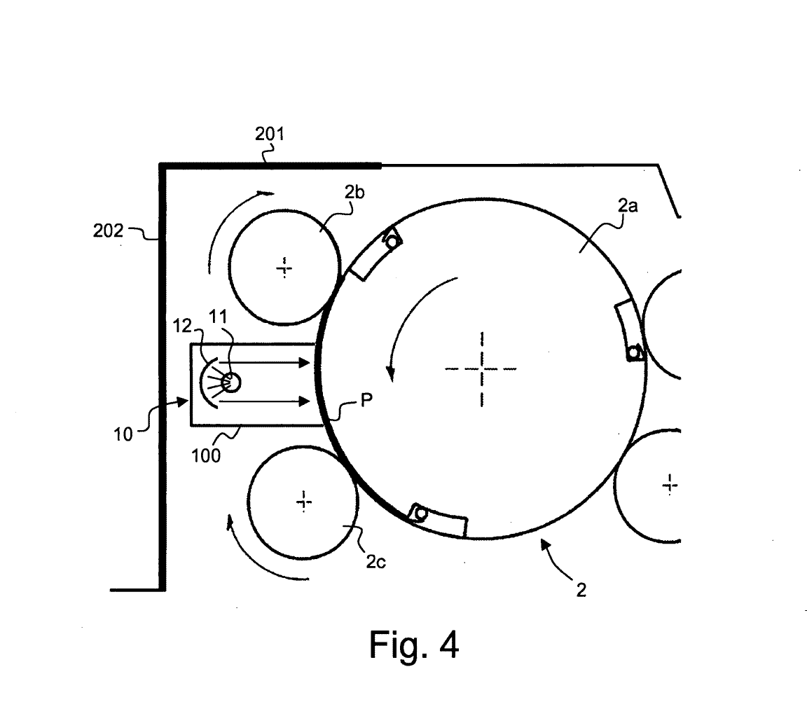

FIG. 4 is a schematic side view of a preferred embodiment of the intermediate drying unit 10. As schematically illustrated, the drying unit 10 preferably comprises a radiation source 11 and reflector 12 designed to subject a sheet P being printed and held by the impression cylinder 2a to drying radiation. The intermediate drying unit 10 is preferably a UV-type dryer for emitting ultraviolet radiation. In this context, the radiation source 11 may be a flash tube containing an inert gas, preferably Xenon, which is advantageously cooled by a cooling fluid. Xenon flash tubes are particularly suitable in that they exhibit a favourable luminous energy/electrical energy yield, especially due to the low infrared radiation (typ. below 10%), as well as very low ozone emissions. For the purpose of the present application, the radiation source 11 may be designed to emit in the UV-A range, i.e. at a wavelength of the order of 315 to 400 nm.

A light shield 100 is preferably further provided, which light shield 100 surrounds the intermediate drying unit 10 for preventing propagation of UV radiation and avoiding interference with the first and second screen printing units 2b, 2c, i.e. prevent initiation of a drying or curing process of the inks in the ink supply of the screen printing units 2b, 2c. This light shield 100 is also preferred for security reasons, i.e. to prevent UV radiation from reaching the printer operating the machine.

As a further security measure, the first and second screen printing units 2b, 2c and the intermediate drying unit 10 may advantageously be housed in a machine frame comprising protective members 201, 202 for protecting an operator from the propagation of UV radiation.

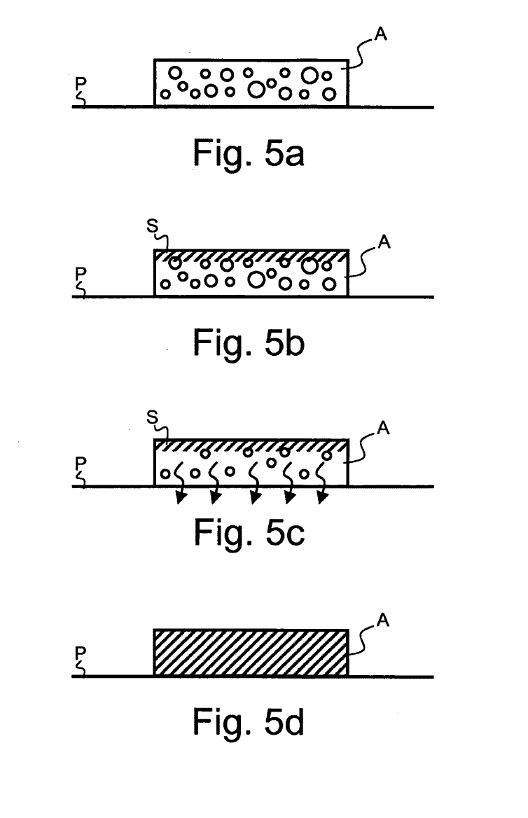

Referring to FIGS. 5a to 5d, one will briefly explain the drying process which is embodied using the printing press of the present invention. In FIGS. 5a to 5d, the ink pattern applied by the first screen printing unit 2b is denoted by reference A. The second ink pattern applied by the second screen printing unit 2c is not shown in FIGS. 5a to 5d. As already mentioned, it will be understood that this second ink pattern can be applied anywhere on the surface of the sheets P (or web portions) once superficial drying of the first ink pattern A has been carried out, even in close proximity to the first ink pattern A or in at least a partially overlapping manner with the first ink pattern A.

FIG. 5a schematically illustrates the first ink pattern A following its application by the first screen printing unit 2b on a sheet of paper P. Under the action of the intermediate drying unit 10, a superficial portion S of the ink pattern A is dried as illustrated in FIG. 5b. This superficial portion S is sufficiently dry to enable contact to be made with the upper surface of the ink pattern A (in particular contact with the surface of the stencil cylinder of the second screen printing unit 2c). As illustrated in FIG. 5c, liquid solvent constituents contained in the screen-printing ink are absorbed by the paper P. This process already starts upon application of the ink pattern A on the surface of the paper P and is further enhanced by the thermal drying unit 5 placed in the sheet delivery path of the printing press. As illustrated in FIG. 5d, the ink pattern A is fully dried and cured following its passage through the UV drying unit 6.

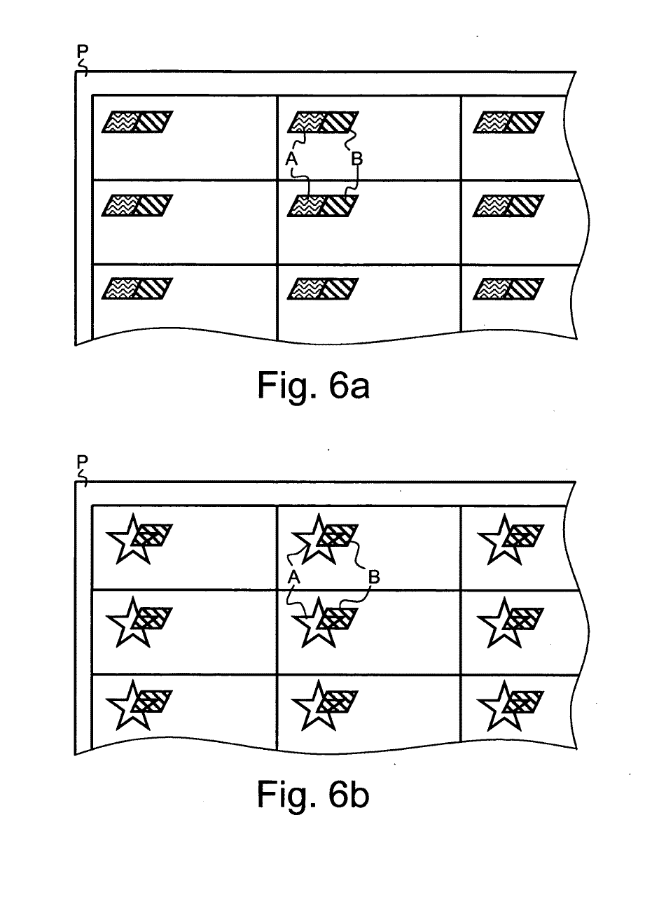

Thanks to the above-described printing press configuration, and in contrast to the known configurations taught in International application No. WO 97/34767, it is now possible to print two different ink patterns in close proximity to one another (e.g. immediately adjacent to one another) or in at least a partially overlapping manner. Possible examples of patterns printable using the above-described printing press are schematically illustrated in FIGS. 6a and 6b.

FIG. 6a schematically illustrates an example wherein a sheet P (which sheet P typically exhibits an array of security imprints arranged in rows and columns) is provided with first and second ink patterns A, B that are applied one next to the other. FIG. 6b schematically illustrates an example wherein a similar sheet P is provided with first and second ink patterns A, B that partially overlap. In such a case, the second ink pattern B can advantageously be printed using a semi-transparent ink or in such a way as to be semi-transparent and enable visualization of the underlying portion of the first ink pattern A. In this way, more complex security features combining the properties of two different silk-screen printing inks can be created.

It will of course be appreciated that the specific shapes and locations of the ink patterns A, B shown in FIGS. 6a, 6b are purely illustrative. One or both ink patterns A, B may furthermore be printed on top of a background (such as an offset background) and/or be overprinted or embossed (e.g. by intaglio printing). Examples of security features combining screen-printed features and features printed by other printing processes such as offset printing and/or intaglio printing are known in the art, for instance from International application No. WO 2004/071781.

Various modifications and/or improvements may be made to the above-described embodiments without departing from the scope of the invention as defined by the annexed claims. For instance, as already mentioned, while the invention has been described in the context of a printing press adapted for sheet printing, the invention is equally applicable to the printing on a continuous web of material. Furthermore, the printing press may comprise more than two successive screen printing units. In such a case, it would be advantageous to locate an intermediate drying unit between each successive pair of screen printing units.

As a further improvement, it may be envisaged to print one or both ink patterns using screen-printing inks containing magnetically-orientable flakes. In such a case, the magnetic flakes could be oriented using a magnetic cylinder as taught in International application No. WO 2005/000585 A1 in the name of the present Applicant.

1. A sheet-fed or web-fed screen printing press, especially for the production of banknotes and like securities, comprising:
an impression cylinder;
a first screen printing unit cooperating with said impression cylinder for applying a first ink pattern onto successive sheets or web portions;
at least a second screen printing unit cooperating with said impression cylinder for applying a second ink pattern onto said successive sheets or web portions, which second screen printing unit is located downstream of the first screen printing unit with respect to a direction of rotation of said impression cylinder; and
an intermediate drying unit located between said first and second screen printing units,
wherein said intermediate drying unit is adapted to perform superficial drying of said first ink pattern applied by the first screen printing unit before application of the second ink pattern by the second screen printing unit, which superficial drying involves only the drying of an outer superficial portion of the first ink pattern.

2. The sheet-fed or web-fed screen printing press according to claim 1, wherein said second screen printing unit is adapted to apply said second ink pattern in close proximity to said first ink pattern or at least in a partially overlapping manner onto said first ink pattern.

3. The sheet-fed or web-fed screen printing press according to claim 1, wherein said intermediate drying unit is a UV unit for emitting UV radiation.

4. The sheet-fed or web-fed screen printing press according to claim 3, wherein said intermediate drying unit comprises one or more flash lamps, such as Xenon flash tubes.

5. The sheet-fed or web-fed screen printing press according to claim 4, wherein said intermediate drying unit is operated at a flash frequency of 40 to 50 Hz for sheet processing speeds of 10,000 to 12,000 sheets per hour.

6. The sheet-fed or web-fed screen printing press according to claim 3, further comprising a light shield surrounding said intermediate drying unit for preventing propagation of UV radiation and avoiding interference with said first and second screen printing units.

7. The sheet-fed or web-fed screen printing press according to claim 3, wherein said first and second screen printing units and said intermediate drying unit are housed in a machine frame comprising protective members for protecting an operator from the propagation of UV radiation.

8. The sheet-fed or web-fed screen printing press according to claim 1, wherein said first and second screen printing units each comprise a stencil cylinder exhibiting a cylindrical outer circumference devoid of any discontinuous portions.

9. The sheet-fed or web-fed screen printing press according to claim 1, further comprising at least one final drying unit placed downstream of the second screen printing unit for final drying of the first and second ink patterns applied by the first and second screen printing units.

10. A method for carrying out screen printing of successive sheets or web portions, especially for the production of banknotes and like securities, onto a screen printing press comprising an impression cylinder, a first screen printing unit cooperating with said impression cylinder for applying a first ink pattern onto successive sheets or web portions, and at least a second screen printing unit cooperating with said impression cylinder for applying a second ink pattern onto said successive sheets or web portions, which second screen printing unit is located downstream of the first screen printing unit with respect to a direction of rotation of said impression cylinder,
said method comprising the step of performing superficial drying of said first ink pattern applied by the first screen printing unit before application of the second ink pattern by the second screen printing unit, which superficial drying involves only the drying of an outer superficial portion of the first ink pattern.

11. The method according to claim 10, further comprising the step of performing final drying of said first and second ink patterns downstream of the second printing unit.
